(19) United States
(12) Patent Application Publication
(10) Pub. No.: US 2005/0237372 A1
(43) Pub. Date: Oct. 27, 2005

(54) Cast Coated Inkjet Paper

(76) Inventors: Noboru Kondo, Tokyo (JP); Yoshio Yoshida, Tokyo (JP); Shoichi Endo, Tokyo (JP); Takayuki Fujimoto, Tokyo (JP)

Correspondence Address: Gary C Cohn, 4010 Lake Washington Boulevard NE, Suite 105, Kirkland, WA, 98033, US

(21) Appl. No.: 10/524,480

(22) PCT Filed: Aug. 12, 2003
(86) PCT No.: PCT/JP03/10273

§ 371 Date: Feb. 11, 2005

(30) Foreign Application Priority Data
Aug. 12, 2002 (JP) 2002-234700

(51) Int. Cl. B41J 3/407

(52) U.S. Cl. 347/106

(57) ABSTRACT

An inkjet recording medium having at least one layer of an ink absorbing layer comprising a pigment and a binder on a base material, wherein the pigment in at least outermost layer of the ink absorbing layer being a cationic pigment, the ink absorbing layer comprises a cationic bis(triazinylamino)stilbene disulfonic acid derivative type fluorescent brightening agent, and surface brightness is at least 90% in terms of ISO brightness as specified in JIS P8148.

### BACKGROUND OF THE INVENTION

1. Field of the Invention

The present invention relates to an inkjet recording medium. The invention is applicable particularly, but not exclusively, to an inkjet recording medium that is suited to printing using a dye ink, yields good gloss and brightness and provides good lightfastness of recorded images.

2. Description of the Prior Art

Inkjet recording generally involves ejecting small droplets of ink using various mechanisms and forming dots by allowing the droplets to adhere to a recording medium. Inkjet recording is less noisy than dot impact recording, can readily provide full color prints, and offers the advantage of potential utility for high speed printing. However, the inks used in inkjet recording have poor drying properties since they ordinarily are water based inks prepared by using direct dyes or acidic dyes.

The recent growth in popularity of high resolution digital videos, digital cameras, scanners and personal computers has increased opportunities to handle high resolution images, and inkjet printers are more frequently used to print hardcopy of these images. As a result, the demands placed on recording media are becoming diversified, and additional demands for recording media having excellent gloss and brightness are intensifying.

The properties demanded of inkjet recording media used in such inkjet recording processes include a faster ink drying speed, high optical (Image) density, the absence of ink blurring and bleeding, and, furthermore, the absence of cockle upon absorption of ink. A method to manufacture an inkjet recording medium accompanied by high image quality to satisfy these properties has already been proposed in Unexamined Japanese Patent Publications (Kokai) Sho 62-95285, Sho 63-264391, Hei 02-274587 and Hei 05-59694.

The inkjet recording medium is obtained in all of these manufacturing methods by transferring a mirror finished surface to a still wet ink absorbing layer comprising a pigment, the major components of which are a synthetic silica, i.e. a non-cationic pigment, and a binder under pressure with a heated mirror finished surface and simultaneously drying said layer. However, in these cases, the gloss of the surface layer was still low.

A recording medium obtained using a cationic pigment containing a alumina hydrate commonly referred to as alumina sol was disclosed, for example, in Unexamined Japanese Patent Publications (Kokai) Hei 05-124330, Hei 06-79967 and Hei 11-91238. The use of a cationic pigment not only makes obtaining high gloss easier than when using a non-cationic pigment, but the ink fixing properties are also good when a cationic pigment is used since the inks used in inkjet recording generally comprise anionic dyes. However, the fluorescent brightening agents used to improve the brightness of an inkjet recording medium are generally anionic. Therefore, problems associated with difficulties in preparing an inkjet recording medium were encountered due to the coagulation of the cationic pigment and an extensive reduction of coating solution stability when an anionic fluorescent brightening agent was added to an ink absorbing layer coating solution to obtain a high brightness. In addition, the combined use of cationic and anionic fluorescent brightening agents caused the lightfastness of recorded images obtained by inkjet recording to decline, and the recorded images underwent extensive discoloration.

A recording medium prepared using a cationic fluorescent brightening agent that does not depress the stability of an ink absorbing layer coating solution even when used in combination with a cationic pigment, unlike an anionic fluorescent brightening agent, was disclosed in Unexamined Japanese Patent Publication (Kokai) Sho 59-52689. However, cationic fluorescent brightening agents such as a cationic benzimidazole type derivative, a cationic coumarin type derivative, a cationic aminocoumarin derivative and the like described in this publication were not very effective in brightening a recording medium, and an excellent brightness could not be obtained. In addition, the lightfastness of recorded images obtained by inkjet recording declined and the discoloration of recorded images extended when a cationic pigment was used in combination with the cationic fluorescent brightening agent, in the same manner as an anionic fluorescent brightening agent.

### SUMMARY OF THE INVENTION

The inventors diligently studied pigments and fluorescent brightening agents in order to resolve the problems described above. As a result, the inventors succeeded in obtaining an inkjet recording medium that simultaneously has excellent gloss and brightness as well as yielding a recorded image providing good lightfastness, because the inkjet recording medium was obtained by combining, at least in the ink absorbing layer of the outermost layer, the use of a cationic pigment and a cationic fluorescent brightening agent having a specific structure, and the present invention is completed based on that success.

Therefore, the object of the present invention is to provides an inkjet recording medium having not only good inkjet recording properties but also excellent gloss, excellent brightness, and good lightfastness for recorded images.

That is, the present invention describes an inkjet recording medium having at least one layer of an ink absorbing layer comprising a pigment and a binder on a base material, wherein said pigment in at least outermost layer of said ink absorbing layer is a cationic pigment, said ink absorbing layer comprises a cationic bis(triazinylamino) stilbene disulfonic acid derivative type fluorescent brightening agent, and surface brightness is 90% or more in terms of ISO brightness as specified in JIS P8148.

In the present invention, preferably surface gloss is 15% or more in terms of 20 degree specular gloss specified in JIS Z8741, and preferably the cationic pigment in said outermost layer of the ink absorbing layer includes an alumina compound. In one preferred mode, the binder in said outermost layer of the ink absorbing layer contains a poly(vinyl alcohol), and said outermost layer of the ink absorbing layer is obtained by a so-called coagulation cast coating method wherein a coating solution containing an alumina compound and poly(vinyl alcohol) is applied onto an air permeable base material to form an ink absorbing layer, and, after a treatment solution that acts to coagulate the poly(vinyl alcohol) on the ink absorbing layer is applied while said ink absorbing layer is wet, and glossy ink absorbing layer is formed by pressing said ink absorbing layer against a heated mirror finished drum surface while the ink absorbing layer is wet to dry the ink absorbing layer.

In addition, preferably the alumina compound in said outermost layer of the ink absorbing layer is a γ type crystalline alumina, and the average particle diameter of the γ type crystalline alumina in said outermost layer of the ink absorbing layer is 1.0 μm to 3.5 μm.

### DESCRIPTION OF THE PREFERRED EMBODIMENTS

(Base Material)

Either an air permeable base material or an air non-permeable base material may be used as the base material of the present invention, but the air permeable base material is preferred since it can readily impart high gloss when used in a cast coating method.

Paper (coated paper, uncoated paper and the like) is particularly preferred as the air permeable base material. As the raw material pulp for said paper, chemical pulp (bleached or unbleached coniferous kraft pulp, bleached or unbleached hard wood kraft pulp and the like), mechanical pulp (ground pulp, thermomechanical pulp, chemithermomechanical pulp and the like), de-inked pulp and the like may be used individually or upon mixing in optional proportions.

The pH of the aforementioned paper may be either acidic, neutral or alkaline. In addition, the presence of a filler is preferred since the opacity of the paper improves. Well known fillers such as hydrated silicic acid, white carbon, talc, kaolin, clay, calcium carbonate, titanium oxide, synthetic resin fillers and the like may be used as the filler. Titanium oxide, kaolin and calcium carbonate are particularly preferred from the standpoint of an extensive improvement in brightness of a base material resulting from the presence of a filler and the ease with which an inkjet recording medium having excellent brightness can be obtained. Titanium oxide is most preferred particularly from the standpoint of extensively improving the brightness.

A plastic resin film base material or a base material composed of a paper covered on at least one side with a plastic resin film may be cited as the air non-permeable base material. A polyester film, a poly(vinyl chloride) film, a polypropylene film, a cellulose triacetate film, a polystyrene film and the like may be cited as the plastic resin film base material. A stock paper obtained by adding a synthetic pulp such as polypropylene or a synthetic fiber such as nylon and polyester when necessary to a wood pulp, the major raw material, and covering at least one side of that paper with a polyolefin resin may be cited as the base material covered with a plastic resin film. Polyethylene is particularly preferred as the polyolefin resin used for the cover.

(Pigment)

Cationic and non-cationic pigments such as alumina and alumina hydrate, alumina sol, colloidal alumina, aluminum hydroxide, silica, kaolin, talc, calcium carbonate, titanium dioxide, clay, zinc oxide and the like may be cited as the pigment contained in the ink absorbing layer in one embodiment of the present invention. They may be used individually or in combination. However, the pigment contained in at least the outermost layer of the ink absorbing layer needs to be a cationic pigment such as alumina and alumina hydrate, alumina sol, colloidal alumina and the like so that the inkjet recording medium obtained has a high gloss. In addition, non-cationic pigments such as silica can also be used as cationic pigments to impart cationic properties by adding a cationic material into a pigment dispersion and subsequently re-dispersing. A cationic pigment refers to a pigment that yields a cationic slurry upon dispersion in water.

Alumina compounds typically represented by the aforementioned alumina and alumina hydrate are preferred as the cationic pigment, and a γ crystalline alumina that readily yields a high gloss in a cast coating method is particularly preferred. The γ type crystalline alumina referred to in the present invention can be obtained by heating and sintering a pseudo Boehmite or Boehmite manufactured using a well known method at a temperature from 400° C. to 900° C. A γ type crystalline alumina manufactured in this manner may be adjusted by grinding and classification to have a desired particle diameter and a desired particle diameter distribution range.

The crystals of γ type crystalline alumina assume a fine flake and adhere well to a heated mirror finished drum in a cast coating method making possible the transfer of the mirror finished drum surface. In addition, γ type crystalline alumina has exceptional clarity for developing color well in inkjet recording. An average particle diameter of 8 μm or smaller is preferred for the γ type crystalline alumina used in the present invention, from 1.0 μm to 3.5 μm is more preferred and from 2.0 μm to 3.0 μm is particularly preferred. The mirror finished surface of a heated mirror finished drum sometimes cannot be adequately transferred and a high gloss recording medium sometimes cannot be obtained when the average particle diameter exceeds 8 μm. In addition, a high gloss recording medium can be obtained when the average particle diameter is less than 1.0 μm, but the ink absorption when using an inkjet printer tends to decline. The average particle diameter described above can be measured using a laser diffraction-scattering method.

(Fluorescent Brightening Agent)

The fluorescent brightening agent present in at least the outermost layer of an ink absorbing layer in the present invention needs to be a cationic bis(triazinylamino) stilbene disulfonic acid derivative type fluorescent brightening agent in order to impart brightness of 90% or more in terms of ISO brightness specified in JIS P8148 to the surface of the inkjet recording medium obtained.

A bis(triazinylamino)stilbene disulfonic acid derivative type fluorescent brightening agent which itself displays a cationic nature is used as the cationic bis(triazinylamino)stilbene disulfonic acid derivative type fluorescent brightening agent of the present invention, but a polymer containing an anionic bis(triazinylamino)stilbene disulfonic acid derivative type fluorescent brightening agent and quaternary ammonium groups to provide an overall cationic nature is also included. In this cationic polymer, preferably the counterion against the quaternary ammonium groups may be an anion group of the anionic bis(triazinylamino)stilbene disulfonic acid derivative type fluorescent brightening agent and the cationic polymer may present in aqueous solution (aqueous solution it self shows cationic nature) from the standpoint of excellent stability of the solution.

The use of an aqueous solution described in Unexamined Japanese Patent Publication (Kohyo) 2002-518568 as the aqueous solution of the cationic polymer described above is preferred in an embodiment of the present invention. That is, the use of an aqueous solution of a polycationic polymer containing quaternary ammonium groups in a salt form as the polymer's hetero atomic chain or cyclic constitutional component wherein a portion of counterion against the quaternary cationic group is the anion group of an anionic fluorescent brightening agent containing at least one anion group is particularly preferred.

The compounds indicated by the chemical formula (from Chemical Formula 5 to Chemical Formula 12) in Examples 1-12 of the above Publication (Kohyo) 2002-518568 (paragraphs 0041-0049 in the publication) and the compounds indicated in Examples 13-16 (paragraphs 0050-0053) can be listed as examples of the anionic bis(triazinylamino)stilbene disulfonic acid derivative type fluorescent brightening agent present in a cationic polymer.

This fluorescent brightening agent may be used in an ink absorbing layer in its outermost layer as well as in ink absorbing layer other than the outermost layer depending on brightness demanded of an inkjet recording medium. Well known fluorescent brightening agents such as bis(triazinylamino)stilbene disulfonic acid derivatives, benzoimidazole derivatives, coumarin derivatives, amino coumarin derivatives, benzooxazole derivatives and the like may be used individually or in combination in the layers of an ink absorbing layer other than its outermost layer. A cationic fluorescent brightening agent refers to a fluorescent brightening agent that yields a cationic solution or cationic slurry when dissolved or dispersed in water.

The addition of from 0.2 part by weight to 4 parts by weight of a cationic bis(triazinylamino)stilbene disulfonic acid derivative type fluorescent brightening agent per 100 parts by weight of a cationic pigment in the outermost layer of an ink absorbing layer is preferred. When the amount added is too large, the whitening effect per amount added declines and the raw material cost rises. Furthermore, the lightfastness of the images tends to decline. When the amount added is too small, the brightness does not improve.

(Binder)

A binder such as poly(vinyl alcohol), poly(vinyl acetal), poly(vinyl pyrolidone), starches like oxidized starch, esterified starch and the like, cellulose derivatives such as carboxymethyl cellulose, hydroxyethyl cellulose and the like, casein, gelatin, soy protein, polystyrene-acrylic resins and their derivatives, poly(styrene-butadiene) resin latexes, acrylic resin emulsions, poly(vinyl acetate) resin emulsions, poly(vinyl chloride) resin emulsions, polyurethane resin emulsions, polyurea resin emulsions and alkyd resin emulsions and derivatives of all may be cited as the binder present in the ink absorbing layer of one embodiment of the present invention. They may be used individually or in combination.

The use of poly(vinyl alcohol) as the binder is particularly preferred when an ink absorbing layer is formed using a cast coating method which a treatment solution that acts to coagulate the binder is applied while the ink absorbing layer is wet, and then said ink absorbing layer is pressed to a heated mirror finished surface to impart gloss. In this case, other binders may be used in combination to the extent that the effect of the present invention is not adversely affected. The poly(vinyl alcohol) may react sufficiently with the aforementioned treatment solution, and the ranges of the degrees of saponification and polymerization may be appropriately selected for this usage.

In addition, an amount of a binder used in an ink absorbing layer of from 5 parts to 30 parts by weight per 100 parts by weight of pigment is preferred but is not particularly restricted as long as the necessary ink absorbing layer strength is obtained. The presence of 30% or more by weight of poly(vinyl alcohol) in the total binder is preferred from the standpoint of improving the strength of the ink absorbing layer. The presence of 50% or more by weight of poly(vinyl alcohol) in the total binder is particularly preferred when forming an ink absorbing layer using a coagulation cast coating method.

(Ink Absorbing Layer Treatment Solution)

Poly(vinyl alcohol) is preferred as the binder in an ink absorbing layer as described above when an ink absorbing layer is formed using a cast coating method to impart gloss by applying a treatment solution that acts to coagulate a binder while the ink absorbing layer is wet, and then pressing said ink absorbing layer onto a heated mirror finished surface. Any aqueous solution containing a compound able to coagulate poly(vinyl alcohol) may be used as an ink absorbing layer treatment solution when poly(vinyl alcohol) is used as the binder, but treatment solutions containing boric acid and a borate are particularly preferred. In addition, the degree of boric acid solubility in water is improved, the state of poly(vinyl alcohol) coagulation is easier to control and a high gloss cast coated paper for inkjet recording is easier to obtain when a borate and boric acid are used as a mixture compared to when boric acid is used alone. Occasionally, a mirror finished drum surface is difficult to transfer, many fine textured imperfections are formed on the surface and high gloss may be difficult to obtain when using a so-called re-wet cast coating method in which an ink absorbing layer is dry when an ink absorbing layer treatment solution is applied.

A weight ratio of borate to boric acid of from 0.25/1 to 2/1 when calculated as anhydrides is particularly preferred in an ink absorbing layer treatment solution. When the formulation ratio of borate/(boric acid) is less than 0.25/1, the proportion of boric acid is too high and the poly(vinyl alcohol) coagulated in the ink absorbing layer may be too soft resulting in the adhesion of a softly coagulated ink absorbing layer onto the rollers used to apply the ink absorbing layer treatment solution and sometimes making it impossible to obtain a good wet ink absorbing layer. Conversely, when the formulation ratio of borate/boric acid exceeds 2/1, the poly(vinyl alcohol) coagulated in the ink absorbing layer becomes hard, the gloss of a cast coated paper surface may declines and an uneven gloss may also be encountered.

The borate used in an embodiment of the present invention may be borax, ortho-borates, di-borates, meta-borates, penta-borates and octa-borates, for example, but not particularly restricted. The use of borax is preferred from the standpoint of ready availability and low cost. The concentrations of a borate and boric acid in an ink absorbing layer treatment solution can be adjusted appropriately as needed. The poly(vinyl alcohol) coagulates firmly and the gloss tends to decline, also crystals tend to precipitate from the treatment solution and the stability of the ink absorbing layer treatment solution declines when the concentrations of the borate and boric acid in the ink absorbing layer treatment solution increase.

(Releasing Agent)

A releasing agent may be added to an ink absorbing layer and an ink absorbing layer treatment solution as necessary when the ink absorbing layer is formed using a cast coating method wherein a treatment solution that acts to coagulate the binder is applied while the ink absorbing layer is wet, and the ink absorbing layer is then pressed onto a heated mirror finished surface to impart gloss. The melting point of the added releasing agent is preferably from 90° C. to 150° C., and from 95° C. to 120° C. is particularly preferred. A releasing agent melting point in the range specified above is almost identical to the temperature of the mirror finished metal surface, and the performance of the releasing agent is maximized. The releasing agent is not particularly restricted as long as it has the properties described above. A polyethylene type wax emulsion is particularly preferred as the releasing agent.

(Coating Method)

A pigment dispersing agent, a water retention agent, a thickener, a antifoaming agent, a preservative, a coloring agent, a waterproofing agent, a wetting agent, a fluorescent dye, an ultraviolet ray absorption agent, a cationic ink fixing agent and the like may be added appropriately when necessary to the coating solution that forms an ink absorbing layer and the ink absorbing layer treatment solution used in a embodiment of the present invention.

The method used to apply a coating solution on a base material may be appropriately selected and used from among well known coating methods when using a coater such as blade coaters, air knife coaters, roller coaters, brush coaters, kiss coaters, squeeze coaters, curtain coaters, die coaters, bar coaters, gravure coaters, comma coaters and the like. A roller type, a spray type and a curtain type can be cited as the method used to apply an ink absorbing layer treatment solution, but the method is not limited to these options.

(Coating Weight)

The coating weight of the ink absorbing layer can be adjusted as desired to cover the surface of a base material and also to yield adequate ink absorption. However, a coating weight of 5 g/m² to 40 g/m² per side in terms of solid content (dry weight) is preferred from the standpoint of optical density and ink absorption. When the coating weight of the ink absorbing layer is less than 5 g/m² ink absorption properties may be deficient even when a base material having good ink absorption is used, and a high resolution printing image may be difficult to obtain. In addition, when the coating weight exceeds 40 g/m² the ink absorbing layer surface may becomes weaker due to, for example, settling of the binder, cracks form easily in the ink absorbing layer surface, and the gloss sometimes declines.

### EXAMPLES

The present invention is explained in further detail by presenting specific examples below, but the present invention is not limited by these examples. In addition, the terms “parts” and “%” described below refer to “parts by weight” and “% by weight” of solid content unless otherwise noted. However, mixed amount of a product (liquid) itself was used for a fluorescent brightening agent.

### Example 1

Twenty parts of titanium oxide, 1.0 part of aluminum sulfate, 0.1 part of synthetic sizing agent and 0.02 part of a yield improving agent were added to a pulp slurry comprising 100 parts of a bleached hard wood kraft pulp (L-BKP) having a degree of beating of 285 ml. The mixture was formed into paper using a paper machine, then starch was applied on both sides of the paper at a solid content of 2.5 g/m² per side to obtain a base material of 142 g/m².

A blade coater was used to apply ink absorbing layer coating solution A shown below on the base material at a coating weight in terms of solid content of 8 g/m² on one side, and the coating was air dried at 140° C. Next, ink absorbing layer coating solution B described below was applied to the surface coated with ink absorbing layer coating solution A at a coating weight in terms of solid content of 20 g/m² using a roller coater. An ink absorbing layer treatment solution was used to coagulate the ink absorbing layer while the ink absorbing layer was wet. Next, the wet ink absorbing layer was pressed onto a heated mirror finished surface using a press roller to transfer the mirror finished surface and to obtain an inkjet recording medium of 170 g/m².

Ink Absorbing Layer Coating Solution A:

Pigment: 100 parts of synthetic silica (Finesil X-37: a trade name of Tokuyama Corp.)
Binder 1: 5 parts of a styrene-butadiene resin latex (LX438C: a trade name of Sumitomo Chemical Company, Ltd)
Binder 2: 20 parts of poly(vinyl alcohol) (PVA 117: a trade name of KURARAY Co., LTD.)
Sizing agent: 5 parts (Polymaron 360: a trade name of Arakawa Chemical Industries, Ltd.)
solid content concentration 20%
   Ink Absorbing Layer Coating Solution B:
Cationic pigment: 100 parts of γ type crystalline alumina (UA 5605: a trade name of Showa Denko. K.K., average particle diameter 2.8 μm)
Fluorescent brightening agent: 4 parts of cationic bis(triazinylamino)stilbene disulfonic acid derivative type fluorescent brightening agent (Leucophor FTS liquid (a 47% solid content solution): a trade name of Clariant Japan K.K.)
Binder 1: 10 parts of poly(vinyl alcohol) (PVA 224: a trade name of KURARAY Co., LTD.)
Binder 2: 5 parts of urethane resin emulsion (F8570 D2: a trade name of Daiichi Kogyo Seiyaku. Co., Ltd)
Antifoaming agent: 0.2 part
Solid content concentration 28%.
   Ink Absorbing Layer Treatment Solution:
Borax: 1.5% (calculated in terms of anhydrides)
Boric acid: 3.0%.
Mold releasing agent: 0.2% (FL-48C: a trade name of Toho Chemical Industry. Co., Ltd)
Solid content concentration: 4.7%

### Example 2

An inkjet recording medium was obtained in the manner described in Example 1 with the exception that the amount of Leucophor FTS liquid used in ink absorbing layer coating solution B described in Example 1 was reduced to 2 parts.

### Example 3

An inkjet recording medium was obtained in the manner described in Example 1 with the exception that the amount of Leucophor FTS liquid used in ink absorbing layer coating solution B described in Example 1 was reduced to 0.5 part.

### Example 4

An inkjet recording medium was obtained in the manner described in Example 1 with the exception that the amount of Leucophor FTS liquid used in ink absorbing layer coating solution B described in Example 1 was increased to 8 parts.

### Example 5

An inkjet recording medium was obtained in the manner described in Example 1 with the exception that the amount of Leucophor FTS liquid used in ink absorbing layer coating solution B described in Example 1 was increased to 10 parts.

### Example 6

An inkjet recording medium was obtained in the manner described in Example 1 with the exception that a silica (Sylojet 703C: a trade name of Grace Japan K.K.) to which a cationic nature had been imparted was used in place of the γ type crystalline alumina as the cationic pigment in ink absorbing layer coating solution B described in Example 1, and the solid content concentration in the ink absorbing layer coating solution was 17%.

### Example 7

An inkjet recording medium was obtained in the manner described in Example 1 with the exception that 15 parts of talc was used in place of the 20 parts of titanium oxide used in the base material in Example 1.

### Example 8

An inkjet recording medium was obtained in the manner described in Example 1 with the exception that 10 parts of an anionic fluorescent brightening agent (Kayaphor PAS liquid: a trade name of Nippon Kayaku. Co., Ltd.) was used in ink absorbing layer coating solution A described in Example 1 and the amount of Leucophor FTS liquid added to ink absorbing layer coating solution B was 0.5 part.

### Example 9

An inkjet recording medium was obtained in the manner described in Example 1 with the exception that ink absorbing layer coating solution A used in Example 1 was not applied and the coating weight in terms of solid content of 28 g/m² of ink absorbing layer coating solution B was applied.

### Example 10

Ink absorbing layer coating solution C described below using a die coater at a coating weight of 30 g/m² in terms of solid content was applied to one side of a 140 g/m² base material which obtained by covering a stock paper on both sides with polyethylene, and after air drying at 40° C., an 170 g/m² inkjet recording medium was obtained.

Ink Absorbing Layer Coating Solution C:

Cationic pigment: 100 parts of alumina sol (AS-2: a trade name of Catalyst & Chemicals Ind. Co., Ltd.)
Fluorescent brightening agent: 4 parts of cationic bis(triazinylamino)stilbene disulfonic acid derivative type fluorescent brightening agent (Leucophor FTS liquid: a trade name of Clariant Japan K.K.)
Binder 1: 10 parts of poly(vinyl acetal) (S-Lec KW-1: a trade name of Sekisui Chemical. Co., Ltd)
Binder 2: 5 parts of poly(vinyl alcohol) (Gohsenol KH-17: a trade name of Nippon Synthetic Chemical Ind. Co., Ltd)
Antifoaming agent: 0.2 part
Solid content concentration 11%.

### Comparative Example 1

An inkjet recording medium was obtained in the manner described in Example 1 with the exception that a synthetic silica (Finesil X-37: a trade name of Tokuyama Corp.), a non-cationic pigment, was used in place of the cationic pigment used in ink absorbing layer coating solution B described in Example 1.

### Comparative Example 2

An inkjet recording medium could not be obtained when an anionic fluorescent brightening agent (Kayaphor PAS liquid: a trade name of Nippon Kayaku. Co., Ltd.) was used in place of the fluorescent brightening agent used in ink absorbing layer coating solution B described in Example 1, because the ink absorbing layer coating solution B thickened so extensively that it could not be coated.

### Comparative Example 3

An inkjet recording medium was obtained in the manner described in Example 1 with the exception that an anionic fluorescent brightening agent (Leucophor NS liquid: a trade name of Clariant Japan K.K.) was used in place of the fluorescent brightening agent used in ink absorbing layer coating solution B described in Example 1.

### Comparative Example 4

An inkjet recording medium was obtained in the manner described in Example 1 with the exception that a cationic benzoimidazole derivative type fluorescent brightening agent (Uvitex BAC liquid: a trade name of Ciba Specialty Chemicals) was used in place of the fluorescent brightening agent used in ink absorbing layer coating solution B described in Example 1.

### Comparative Example 5

An inkjet recording medium was obtained in the manner described in Example 1 with the exception that the Leucophor FTS liquid used in ink absorbing layer coating solution B described in Example 1 was not used.

### Comparative Example 6

An inkjet recording medium was obtained in the manner described in Example 1 with the exception that 10 parts of an anionic fluorescent brightening agent (Kayaphor PAS liquid: a trade name of Nippon Kayaku. Co., Ltd.) was added to ink absorbing layer coating solution A and no Leucophor FTS liquid was added to ink absorbing layer coating solution B described in Example 1.

The gloss and the brightness of the inkjet recording media obtained in Examples 1-10, Comparative Example 1 and Comparative Examples 3-6 were evaluated and an inkjet recording test was conducted on the same samples according to the methods shown below. The results are summarized in Table 1. When the evaluation symbols shown in the table are O-A, the recording media obtained could be used without encountering significant problems.

(1) Gloss.

20 degree specular gloss was measured for the ink absorbing layer surface of an inkjet recording medium according to the method of JIS Z8741. A high gloss was achieved when 20 degree specular gloss was 15% or more.

(2) Brightness.

ISO brightness of the ink absorbing layer surface of an inkjet recording medium was measured according to the method of JIS P8148. When ISO brightness was 90% or more, the recording medium was judged to have an excellent brightness. The quantity of ultraviolet light of the irradiation on a test specimen was adjusted to CIE illuminant C, and the measured value when ultraviolet light is included was defined as the ISO brightness.

(3) Inkjet Recording Test.

A recording test was conducted by recording a designated pattern using an inkjet printer (PM-950C: a trade name of Seiko Epson Corp.) and using the standards shown below.

a. Optical Density.

The density of solid image patterns in black, cyan, magenta and yellow was measured using a Macbeth Densitometer (RD915: a trade name of Gretag Macbeth AG.), and the sum of measured values was defined as the optical density.

b. Ink Absorption (Bleeding).

The bleeding along a boundary between red (a mixture of magenta and yellow) and green (a mixture of cyan and yellow) in solid images adjacent to each other was visually measured according to the standards shown below. The bleeding in the boundary between red and green was black, so more stringent evaluation was possible.
◯: No bleeding was observed along the boundary.
Δ: Some bleeding was observed along the boundary.
X: Severe bleeding was observed along the boundary.
c: Lightfastness of recorded image.

The optical density after a magenta solid pattern was treated 24 hours using a Xenon Weathermeter (SC-700-WN: a trade name of Suga Test Instruments Co., Ltd.) was measured using a Macbeth Densitometer (RD915: a trade name of Gretag Macbeth AG.), and the percentage of the residual optical density was evaluated according to the standards shown below based on the optical density prior to the treatment.
O: The percentage of the residual optical density was at least 80%.
Δ: The percentage of the residual optical density was at least 70% but less than 80%.

X: The percentage of the residual optical density was less than 70%.

TAABLE 1

| | | | | | | | Optical | | |
|---|---|---|---|---|---|---|---|---|---|
| Coating solution A | | Coating solution B or C | | | Gloss | Brightness | density | | |
| | | | | | 20 degree | ISO | Four | | light- |
| Fluorescent | Amount | | Fluorescent | Amount | specular | brightness | color | Ink | fastness |
| brightning agent | added | Pigment | brightning agent | added | gloss (%) | (%) | total | absortion | of Image |
| — | — | UA5605 | Leucophor FTS liquid | 4.0 | 29.8 | 95.8 | 8.18 | ◯ | ◯ |
| — | — | UA5605 | Leucophor FTS liquid | 2.0 | 29.8 | 94.2 | 8.22 | ◯ | ◯ |
| — | — | UA5605 | Leucophor FTS liquid | 0.5 | 30.0 | 90.9 | 8.26 | ◯ | ◯ |
| — | — | UA5605 | Luecophor FTS liquid | 8.0 | 29.1 | 100.6 | 8.11 | ◯ | ◯ |
| — | — | UA5605 | Luecophor FTS liquid | 10.0 | 28.5 | 101.1 | 8.05 | ◯ | Δ |
| — | — | Syrojet 703C | Leucophor FTS liquid | 4.0 | 15.8 | 95.1 | 7.74 | ◯ | ◯ |
| — | — | UA5605 | Leucophor FTS liquid | 4.0 | 25.2 | 93.5 | 8.2 | ◯ | ◯ |
| Kayaphor PAS liquid | 10 | UA5605 | Leucophor FTS liquid | 0.5 | 29.9 | 91.4 | 8.25 | ◯ | ◯ |
| Coating solution A not applied | | UA5605 | Leucophor FTS liquid | 4.0 | 23.7 | 95.5 | 8.16 | ◯ | ◯ |
| — | — | AS-2 | Leucophor FTS liquid | 4.0 | 15.5 | 94.1 | 8.09 | Δ | ◯ |
| — | — | X-37 | Leucophor FTS liquid | 4.0 | 7.4 | 94.7 | 7.58 | ◯ | ◯ |
| — | — | UA5605 | Kayaphor PAS liquid | 4.0 | Coating solution B could not be applied | | | | |
| — | — | UA5605 | Leucophor NS liquid | 4.0 | 16.9 | 90.4 | 7.67 | ◯ | X |
| — | — | UA5605 | Uvitex BAC liquid | 4.0 | 28.6 | 88.7 | 7.88 | ◯ | X |
| — | — | UA5605 | — | — | 30.1 | 88.0 | 8.28 | ◯ | ◯ |
| Kayaphor PAS liquid | 10 | UA5605 | — | — | 30.1 | 88.5 | 8.26 | ◯ | ◯ |

The data presented in Table 1 clearly indicated that the inkjet recording media of the embodiments of the present invention obtained in Examples 1-10 having both excellent gloss and brightness of its ink absorbing layer surfaces, and proved in practice that the optical density, ink absorption and lightfastness of recorded image were balanced and good. On the other hand, the recording medium containing only a non-cationic pigment in the outermost layer of the ink absorbing layer obtained in Comparative Example 1 had excellent brightness but inadequate gloss. Furthermore, an anionic fluorescent brightening agent as well as a cationic pigment was present in the outermost layer of the ink absorbing layer in Comparative Examples 2 and 3, and either the ink absorbing layer coating solution thickened so extensively that it could not be coated or the lightfastness was poor even when a recording image was obtained. The gloss was excellent but a sufficient brightness could not be achieved in those cases when a cationic fluorescent brightening agent other than a bis(triazinylamino)stilbene disulfonic acid derivative was present in the outermost layer of the ink absorbing layer along with a cationic pigment in Comparative Example 4 and when a cationic bis(triazinylamino)stilbene disulfonic acid derivative fluorescent brightening agent was not present in the outermost layer of the ink absorbing layer in Comparative Examples 5 and 6. The lightfastness of a recorded image was particularly poor in Comparative Example 4. These results proved the validity of the present invention.

An inkjet recording medium of the embodiments of the present invention not only has excellent brightness, excellent gloss and high quality but also has excellent inkjet recording properties and also good lightfastness of recorded image.

The invention may be embodied in other specific forms without departing from the spirit or essential characteristics thereof. The present embodiment is therefore to be considered in all aspects as illustrative and not restrictive, the scope of the invention being indicated be appended claims rather than by the foregoing description and all changes which come within the meaning and range of equivalency of the claims are therefore intended to be embraced therein.

1. An inkjet recording medium having at least one layer of an ink absorbing layer comprising a pigment and a binder on a base material, wherein said pigment in at least outermost layer of said ink absorbing layer is a cationic pigment, said ink absorbing layer comprises a cationic bis(triazinylamino)stilbene disulfonic acid derivative type fluorescent brightening agent, and surface brightness is 90% or more in terms of ISO brightness as specified in JIS P8148.

2. The inkjet recording medium as defined in claim 1 wherein surface gloss is 15% or more in terms of 20 degree specular gloss specified in JIS Z8741.

3. The inkjet recording medium as defined in claim 1 wherein the cationic pigment in said outermost layer of the ink absorbing layer includes an alumina compound.

4. The inkjet recording medium as defined in claim 2 wherein the cationic pigment in said outermost layer of the ink absorbing layer includes an alumina compound.

5. The inkjet recording medium as defined in claim 1 wherein the binder in said outermost layer of the ink absorbing layer contains a poly(vinyl alcohol).

6. The inkjet recording medium as defined in claim 2 wherein the binder in said outermost layer of the ink absorbing layer contains a poly(vinyl alcohol).

7. The inkjet recording medium as defined in claim 3 wherein the binder in said outermost layer of the ink absorbing layer contains a poly(vinyl alcohol).

8. The inkjet recording medium as defined in claim 4 wherein the binder in said outermost layer of the ink absorbing layer contains a poly(vinyl alcohol).

9. The inkjet recording medium as defined in claim 1 wherein said base material has air permeablity and the outermost layer of the ink absorbing layer is a glossy ink absorbing layer obtained by a coagulateing cast coating method.

10. The inkjet recording medium as defined in claim 2 wherein said base material has air permeablity and the outermost layer of the ink absorbing layer is a glossy ink absorbing layer obtained by a coagulateing cast coating method.

11. The inkjet recording medium as defined in claim 3 wherein said base material has air permeablity and the outermost layer of the ink absorbing layer is a glossy ink absorbing layer obtained by a coagulateing cast coating method.

12. The inkjet recording medium as defined in claim 4 wherein said base material has air permeablity and the outermost layer of the ink absorbing layer is a glossy ink absorbing layer obtained by a coagulateing cast coating method.

13. The inkjet recording medium as defined in claim 5 wherein said base material has air permeablity and the outermost layer of the ink absorbing layer is a glossy ink absorbing layer obtained by a coagulateing cast coating method.

14. The inkjet recording medium as defined in claim 6 wherein said base material has air permeablity and the outermost layer of the ink absorbing layer is a glossy ink absorbing layer obtained by a coagulateing cast coating method.

15. The inkjet recording medium as defined in claim 7 wherein said base material has air permeablity and the outermost layer of the ink absorbing layer is a glossy ink absorbing layer obtained by a coagulateing cast coating method.

16. The inkjet recording medium as defined in claim 8 wherein said base material has air permeablity and the outermost layer of the ink absorbing layer is a glossy ink absorbing layer obtained by a coagulateing cast coating method.

17. The inkjet recording medium as defined in claim 3 wherein the alumina compound in said outermost layer of the ink absorbing layer is a γ type crystalline alumina.

18. The inkjet recording medium as defined in claim 4 wherein the alumina compound in said outermost layer of the ink absorbing layer is a γ type crystalline alumina.

19. The inkjet recording medium as defined in claim 17 wherein the average particle diameter of the γ type crystalline alumina in said outermost layer of the ink absorbing layer is 1.0 μm to 3.5 μm.

20. The inkjet recording medium as defined in claim 18 wherein the average particle diameter of the γ type crystalline alumina in said outermost layer of the ink absorbing layer is 1.0 μm to 3.5 μm.
